(19) United States
(12) Patent Application Publication
(10) Pub. No.: US 2026/0351229 A1
(43) Pub. Date: Nov. 5, 2026

(54) MASKING SOUND SELECTION DEVICE, PROGRAM, AND MASKING SOUND SELECTION METHOD

(71) Applicant: D&M Holdings Inc., Kanagawa (JP)

(72) Inventor: Toru Nozaki, Kanagawa (JP)

(73) Assignee: D&M Holdings Inc., Kanagawa (JP)

(21) Appl. No.: 19/485,666

(22) PCT Filed: May 16, 2024
(86) PCT No.: PCT/JP2024/018063

§ 371 Date: Nov. 18, 2025

(30) Foreign Application Priority Data
May 22, 2023 (JP) 2023-084201

(51) Int. Cl. G10K 11/175

(52) U.S. Cl. CPC G10K 11/1752

(57) ABSTRACT

[Problem] To provide a technology with which it is possible to automatically select a masking sound with a high masking effect for ambient noise and the like. [Solution] A wireless speaker 1 comprises: a masking sound information storage unit 15 in which the name of a masking sound is stored for each noise type; a sound collection unit 16 that collects an ambient sound; a frequency characteristic analysis unit 17 that analyzes the frequency characteristic of audio data of the ambient sound collected by the sound collection unit 16; and a masking sound selection unit 18 that, on the basis of the frequency characteristic analyzed by the frequency characteristic analysis unit 17, specifies the noise type of the ambient sound. The masking sound selection unit 18 selects, as a masking sound to be superimposed on the ambient sound, a masking sound specified by the name stored in the masking sound information storage unit 15 in association with the specified noise type.

### TECHNICAL FIELD

The present invention relates to a masking technology against noises such as sounds of an automobile traveling, sounds of a factory in operation, and sounds of other people talking.

### BACKGROUND ART

There has been known a masking effect which makes unpleasant noises such as sounds of an automobile traveling, sounds of a factory in operation, and sounds of other people talking less clear to hear by overlaying sounds (masking sounds) that have frequencies close to frequencies of the noises on the noises. Outputting a masking sound that has the masking effect on a noise in surroundings enables a user to spend time in a relaxed state without a care for the noise in the surroundings (Patent Literature 1 and Non Patent Literature 1).

### CITATION LIST

### Patent Literature

[PTL 1] JP 2015-57621 A

### Non Patent Literature

[NPL 1] [NPL 1] “TECCELL SAINT COLUMN: What is Sound Masking? Learn about Its Overview, Effects, When to Use It, etc.,” [online], Gifu Plastic Industry Co., Ltd., [retrieved on Apr. 11, 2023], Internet, <URL: http://teccell.co.jp/saint/column/sound-masking/>

### SUMMARY OF INVENTION

### Technical Problem

A masking sound high in masking effect varies depending on the type of the noise. It is a bother for the user to seek out a masking sound that has a high masking effect depending on a noise in the surroundings.

The present invention has been made in view of the circumstance described above, and an object of the present invention is to provide a technology that enables automatic selection of a masking sound that has a high masking effect on a noise in the surroundings.

### Solution to Problem

In order to solve the above-mentioned problem, in the present invention, information about a masking sound having a high masking effect is registered in advance for each noise type. Then, the noise type of a collected ambient sound is identified based on a frequency characteristic of audio data of the ambient sound, and a masking sound that is identified from a piece of information registered in advance in association with the identified noise type is selected as a masking sound to be overlaid on the ambient sound.

For example, according to one embodiment of the present invention, there is provided a masking sound selection device for selecting a masking sound to be overlaid on an ambient sound, the masking sound selection device including: masking sound information storage means for storing, for each noise type, information about a masking sound; sound collection means for collecting the ambient sound; frequency characteristic analysis means for analyzing a frequency characteristic of audio data of the ambient sound collected by the sound collection means; and masking sound selection means for identifying a noise type of the ambient sound based on the frequency characteristic analyzed by the frequency characteristic analysis means, and selecting, as the masking sound to be overlaid on the ambient sound, a masking sound that is identified from a piece of information stored in the masking sound information storage means in association with the noise type.

For example, according to one embodiment of the present invention, there is provided a masking sound selection device for selecting a masking sound to be overlaid on an ambient sound, the masking sound selection device including: masking sound information storage means for storing, for each noise type, information about a masking sound; sound collection means for collecting the ambient sound; frequency characteristic analysis means for analyzing a frequency characteristic of audio data of the ambient sound collected by the sound collection means; and masking sound selection means for identifying a noise type of the ambient sound based on the frequency characteristic analyzed by the frequency characteristic analysis means, and selecting, as the masking sound to be overlaid on the ambient sound, a masking sound that is identified from a piece of information stored in the masking sound information storage means in association with the noise type.

### Advantageous Effects of Invention

In the present invention, the noise type of the collected ambient sound is identified based on the frequency characteristic of the audio data of the ambient sound, and the masking sound that is identified from the piece of information registered in advance in association with the identified noise type is selected. Thus, according to the present invention, a masking sound high in masking effect on a noise in the surroundings is automatically selected by registering information about a masking sound that has a high masking effect for each noise type in advance.

### BRIEF DESCRIPTION OF DRAWINGS

FIG. 1 is a schematic configuration diagram of an audio system in one embodiment of the present invention.

FIG. 2 is a schematic function configuration diagram of a wireless speaker (1).

FIG. 3 is a table for schematically showing an example of registered contents of a masking sound information storage unit (15).

FIG. 4 is a flow chart for illustrating a masking sound reproduction operation of the wireless speaker (1).

### DESCRIPTION OF EMBODIMENTS

Now, one embodiment of the present invention is described.

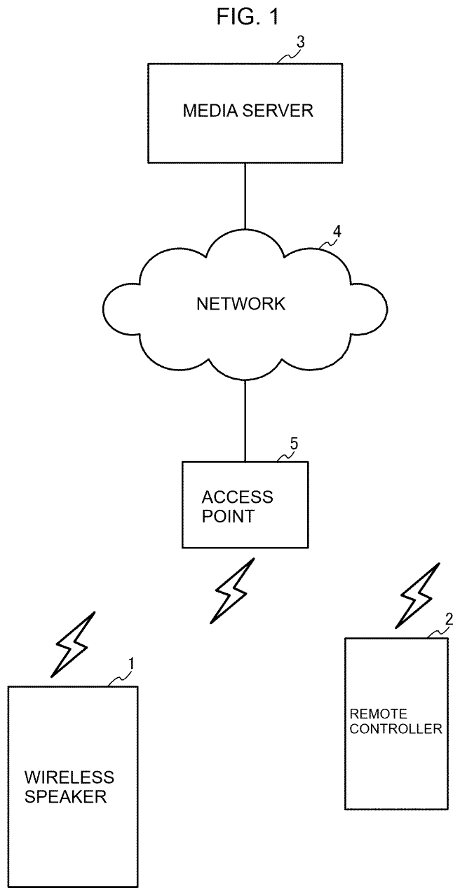

FIG. 1 is a schematic configuration diagram of an audio system in this embodiment.

As illustrated, the audio system in this embodiment includes a wireless speaker 1, a remote controller 2, and a media server 3 which distributes audio data including a masking sound.

The wireless speaker 1 and the remote controller 2 are connected, via an access point 5, to a network 4 such as a wide area network (WAN) or a local area network (LAN). The media server 3 is connected to the network 4.

The wireless speaker 1 receives a reproduction instruction accompanied by specification of a tune via the access point 5 from the remote controller 2, then accesses the media server 3 via the access point 5 and the network 4, downloads audio data of the tune specified in the reproduction instruction from the media server 3, and reproduces and outputs the audio data. The wireless speaker 1 also receives a relaxation mode transition instruction via the access point 5 from the remote controller 2, and then selects a masking sound that has a high masking effect on an ambient sound including a noise. The wireless speaker 1 then accesses the media server 3 via the access point 5 and the network 4, downloads audio data of the selected masking sound from the media server 3, and reproduces and outputs the audio data.

Next, details of the wireless speaker 1 included in the audio system in this embodiment are described.

An existing wireless terminal such as a smartphone or a tablet personal computer (PC) is usable for the remote controller 2, and an existing media server that delivers requested audio data to a requester is usable for the media server 3. Accordingly, detailed descriptions on the remote controller 2 and the media server 3 are omitted.

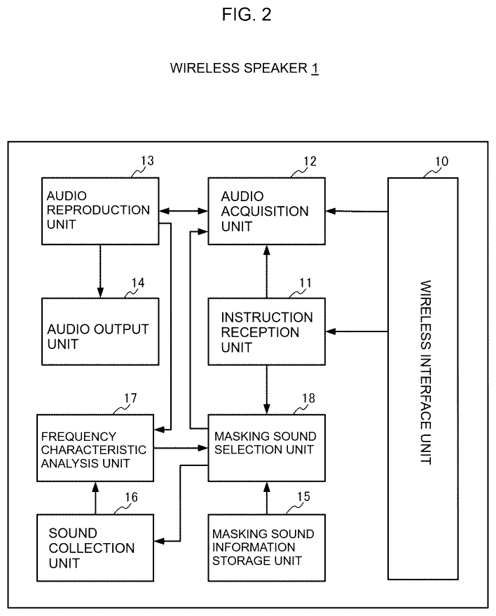

FIG. 2 is a schematic function configuration diagram of the wireless speaker 1.

As illustrated, the wireless speaker 1 includes a wireless interface unit 10, an instruction reception unit 11, an audio acquisition unit 12, an audio reproduction unit 13, an audio output unit 14, a masking sound information storage unit 15, a sound collection unit 16, a frequency characteristic analysis unit 17, and a masking sound selection unit 18.

The wireless interface unit 10 is an interface for connecting to the access point 5.

The instruction reception unit 11 receives various instructions from the remote controller 2 via the wireless interface unit 10.

The audio acquisition unit 12 accesses the media server 3 via the wireless interface unit 10 to acquire, from the media server 3, audio data of a tune specified by the instruction reception unit 11, or audio data of a masking sound specified by the masking sound selection unit 18.

The audio reproduction unit 13 reproduces the audio data acquired by the audio acquisition unit 12.

The audio output unit 14 outputs the audio data reproduced by the audio reproduction unit 13, from a built-in or external speaker (not shown).

The masking sound information storage unit 15 stores, for each type of noise (noise type), one or more pieces of information about masking sounds in association with reproduction time slots of the masking sounds.

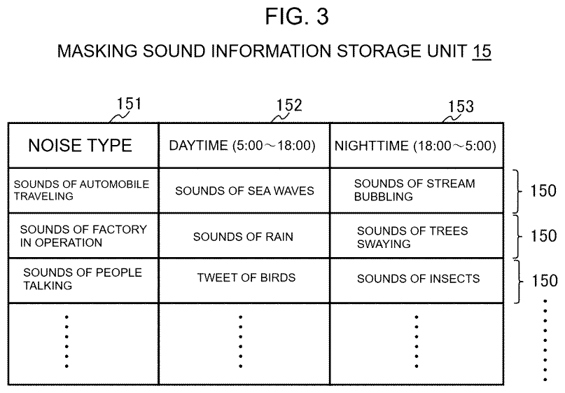

FIG. 3 is a table for schematically showing an example of registered contents of the masking sound information storage unit 15.

As shown, the masking sound information storage unit 15 stores a record 150 of masking sound information for each noise type. This record 150 includes a field 151 in which a noise type is registered, and one or more fields which store names of masking sounds that have a high masking effect on noises belonging to this noise type. In this embodiment, each record 150 has two fields of the fields 152 and 153 which store names of masking sounds. One field, which is the field 152, stores the name of a masking sound appropriate to be heard during daytime (a reproduction time slot “5:00-18:00”), and another field, which is the field 153, stores the name of a masking sound appropriate to be heard during nighttime (a reproduction time slot “18:00-5:00”). In this embodiment, a day is divided into two time slots (daytime and nighttime) and, for each time slot, the name of a masking sound suitable for the time slot is registered in the record 150. However, a day may be divided into three or more time slots (morning, day, evening, night, and the like) to register, for each time slot, the name of a masking sound suitable for the time slot in the record 150.

The sound collection unit 16 collects, by following an instruction of the masking sound selection unit 18, an ambient sound with a built-in or external microphone (not shown), and outputs audio data of the collected ambient sound to the frequency characteristic analysis unit 17.

The frequency characteristic analysis unit 17 analyzes a frequency characteristic of the audio data of the ambient sound collected by the sound collection unit 16. In a case in which the audio reproduction unit 13 is reproducing audio data of a masking sound, the frequency characteristic analysis unit 17 extracts differential data that represents a difference between the audio data of the ambient sound collected by the sound collection unit 16 and the audio data of the masking sound that is being reproduced, and analyzes a frequency characteristic of the extracted differential data.

The masking sound selection unit 18 identifies a noise type to which the ambient sound belongs, based on the frequency characteristic analyzed by the frequency characteristic analysis unit 17. For example, the masking sound selection unit 18 stores typical frequency characteristics of noises stored for respective noise types in the masking sound information storage unit 15, and searches those frequency characteristics for a frequency characteristic closest to the frequency characteristic analyzed by the frequency characteristic analysis unit 17. The masking sound selection unit 18 then identifies a noise type that is associated with the frequency characteristic found through the search, as the noise type of the ambient sound. The masking sound selection unit 18 also selects, as the name of a masking sound to be overlaid on the ambient sound, the name of a masking sound stored in the masking sound information storage unit 15 in association with the identified noise type of the ambient sound and with a reproduction time slot (daytime or nighttime) in which the current time is included. The masking sound selection unit 18 then notifies the name of the selected masking sound to the audio acquisition unit 12, and issues an instruction to reproduce the masking sound.

The functional configuration of the wireless speaker 1 illustrated in FIG. 2 may be implemented by hardware through use of an integrated logic IC such as an application specific integrated circuit (ASIC) or a field programmable gate array (FPGA), or may be implemented by software through use of a computer such as a digital signal processor (DSP). As another example, the functional configuration may be implemented as a process on a general-purpose computer, such as a personal computer (PC), including a central processing unit (CPU), a memory, an auxiliary storage device such as a flash memory or a hard disk drive, a wireless communication device such as a wireless LAN adapter, and a built-in or external audio device (microphone or speaker), by the CPU loading a predetermined program into the memory from the auxiliary storage device and executing the program.

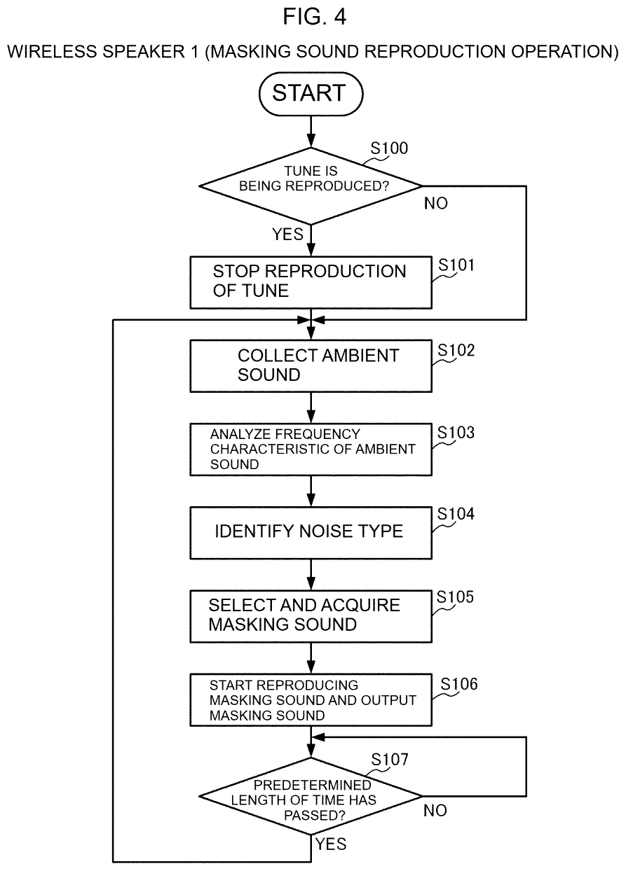

FIG. 4 is a flow chart for illustrating a masking sound reproduction operation of the wireless speaker 1.

This flow is started upon reception of the relaxation mode transition instruction from the remote controller 2 via the wireless interface unit 10 by the instruction reception unit 11.

First, the instruction reception unit 11 instructs the audio acquisition unit 12 to transition to a relaxation mode. The audio acquisition unit 12 receives the instruction and, when the audio reproduction unit 13 is reproducing audio data of a tune (YES in Step S100), causes the reproduction of the audio data of this tune to stop (Step S101). The process then proceeds to Step S102. In contrast, when the audio reproduction unit 13 is not reproducing audio data of a tune (NO in Step S100), the process immediately proceeds to Step S102.

Next, in Step S102, the instruction reception unit 11 instructs the masking sound selection unit 18 to transition to the relaxation mode. The masking sound selection unit 18 receives the instruction, and instructs the sound collection unit 16 to start collecting a sound. The sound collection unit 16 receives the instruction and collects an ambient sound (Step S102). The sound collection unit 16 then hands over audio data of the collected ambient sound to the frequency characteristic analysis unit 17.

Next, the frequency characteristic analysis unit 17 analyzes a frequency characteristic of the audio data of the ambient sound that has been received from the sound collection unit 16 (Step S103), and hands over a result of the analysis to the masking sound selection unit 18. The masking sound selection unit 18 receives the result, and searches the typical frequency characteristics of noises which are registered for each noise type in advance, for a frequency characteristic closest to the frequency characteristic received from the frequency characteristic analysis unit 17. The masking sound selection unit 18 then identifies a noise type that is associated with the frequency characteristic found through the search, as the noise type of the ambient sound (Step S104).

Next, the masking sound selection unit 18 selects, as the name of a masking sound to be overlaid on the ambient sound, the name of a masking sound that is stored in the masking sound information storage unit 15 in association with the identified noise type of the ambient sound and with a reproduction time slot in which the current time is included. The masking sound selection unit 18 then notifies the selected masking sound name to the audio acquisition unit 12, and issues an instruction to reproduce the masking sound. The audio acquisition unit 12 receives the instruction, and accesses the media server 3 via the wireless interface unit 10 to acquire, from the media server 3, audio data of the masking sound the name of which has been notified from the masking sound selection unit 18 (Step S105). The audio acquisition unit 12 then outputs the acquired audio data of the masking sound to the audio reproduction unit 13.

Next, the audio reproduction unit 13 starts reproducing the audio data of the masking sound that has been received from the audio acquisition unit 12, and outputs the masking sound from the audio output unit 14 (Step S106).

Then, upon elapse of a predetermined length of time (for example, 5 minutes) since the audio data of the masking sound is started to be reproduced (YES in Step S107), the process returns to Step S102. In the subsequent Step S103, the frequency characteristic analysis unit 17 extracts differential data that represents a difference between the audio data of the ambient sound that has been received from the sound collection unit 16 and the audio data of the masking sound that is being reproduced by the audio reproduction unit 13, analyzes a frequency characteristic of the extracted differential data, and hands over a result of the analysis to the masking sound selection unit 18.

In the above, one embodiment of the present invention has been described.

In this embodiment, a noise type of a collected ambient sound is identified based on a frequency characteristic of audio data of the ambient sound, and a masking sound the name of which is associated with the identified noise type is acquired from the media server 3 to be reproduced and output. Thus, according to this embodiment, a masking sound that has a high masking effect on a noise in surroundings can automatically be selected and output by registering the name of a masking sound high in masking effect in advance for each noise type.

This embodiment also involves, in the case in which audio data of a masking sound is being reproduced, extracting differential data that represents a difference between audio data of a collected ambient sound and the audio data of the masking sound that is being reproduced, and identifying a noise type of the ambient sound based on a frequency characteristic of the extracted differential data. Thus, according to this embodiment, in a case in which the noise in the surroundings changes during reproduction of a masking sound, the masking sound that is being reproduced is automatically switched to a masking sound that has a high masking effect on the changed noise in the surroundings. Accordingly, a masking sound high in masking effect can always be output despite changes of the noise in the surroundings.

In addition, in this embodiment, the names of a plurality of masking sounds are stored for each noise type, with each masking sound name being associated with a reproduction time slot (daytime or nighttime), and a masking sound the name of which is stored in association with the noise type of an ambient sound and with a reproduction time slot in which the current time is included is acquired from the media server 3 to be reproduced and output. Accordingly, the masking sound can be switched to suit the reproduction time slot thereof, and this enables automatic selection and output of a masking sound that is, for example, preferred in a relevant time slot out of masking sounds having a high masking effect on the noise in the surroundings.

The present invention is not limited to the embodiment described above, and various modifications may be made thereto within the scope of the gist of the present invention.

For example, in the embodiment described above, the wireless speaker 1 acquires a masking sound the name of which is associated with the noise type of the ambient sound from the media server 3 to reproduce and output the masking sound. However, the present invention is not limited thereto. The wireless speaker 1 may acquire a masking sound the name of which is associated with the noise type of the ambient sound from a masking sound storage unit to reproduce and output the masking sound, by providing the wireless speaker 1 with the masking sound storage unit in which one or more masking sounds are stored, and registering the name of each masking sound of the masking sound storage unit in the masking sound information storage unit 15 in association with a noise type.

In the embodiment described above, the wireless speaker 1 stores the names of a plurality of masking sounds for each noise type, with each masking sound name being associated with a reproduction time slot. However, the present invention is not limited thereto. It is sufficient for the wireless speaker 1 to select one masking sound name associated with the noise type of the ambient sound and reproduce and output a masking sound that has the selected name.

For example, the masking sound information storage unit 15 may be designed so as to store one masking sound name for each noise type. In this case, the wireless speaker 1 reproduces and outputs one type of masking sound that is associated with the noise type of the ambient sound regardless of the time slot.

The masking sound information storage unit 15 may also store, for each noise type, the names of a plurality of masking sounds, with each masking sound name being associated with a state of the user's mind and body (active, calm, or the like) so that a masking sound the name of which is associated with the noise type of the ambient sound and with an identified state of the user's mind and body is reproduced and output by using the wireless speaker 1 to acquire the user's biological information from a wearable terminal which has a function of measuring biological information including heart rate and blood pressure, and to identify the state of the user's mind and body from this biological information. This enables the wireless speaker 1 to output a masking sound that has a high masking effect on the noise in the surroundings and that is also suitable for the state of the user's mind and body. The wearable terminal may be a wireless terminal (for example, the wireless terminal used as the remote controller 2).

In the embodiment described above, the wireless speaker 1 collects an ambient sound, identifies the noise type of the ambient sound through analysis of the frequency characteristic of data of the collected sound, and reproduces and outputs audio data of a masking sound the name of which is associated with the identified noise type. However, the present invention is not limited thereto. For example, the remote controller 2 may collect an ambient sound, identify the noise type of the ambient sound through analysis of the frequency characteristic of audio data of the ambient sound, and cause the wireless speaker 1 to reproduce and output a masking sound by notifying a reproduction instruction accompanied by specification of a name of a masking sound that is associated with the identified noise type to the wireless speaker 1, or by transmitting, to the wireless speaker 1, audio data of this masking sound which is acquired from the media server 3 or read out of pre-registered pieces of audio data of masking sounds.

In this case, the masking sound information storage unit 15, the sound collection unit 16, the frequency characteristic analysis unit 17, and the masking sound selection unit 18 which are illustrated in FIG. 2 are provided in the remote controller 2, and are unrequired for the wireless speaker 1. The remote controller 2 is further provided with a reproduction instruction unit which notifies a reproduction instruction accompanied by specification of a name of a masking sound to the wireless speaker 1, or a masking sound transmission unit which transmits audio data of a masking sound (audio data of a masking sound that is acquired from the media server 3, or audio data of a masking sound that is read out of pre-registered pieces of audio data of masking sounds) to the wireless speaker 1.

In the case in which the remote controller 2 is provided with the masking sound transmission unit along with the masking sound information storage unit 15, the sound collection unit 16, the frequency characteristic analysis unit 17, and the masking sound selection unit 18, during reproduction of a masking sound by the wireless speaker 1, the remote controller 2 collects an ambient sound after a predetermined length of time passes since the reproduction of the masking sound is started, extracts differential data that represents a difference between audio data of that ambient sound and audio data of the masking sound that has been transmitted to the wireless speaker 1 by the masking sound transmission unit and that is being reproduced, and identifies a noise type of the ambient sound based on a frequency characteristic of this differential data. The remote controller 2 then notifies a reproduction instruction accompanied by specification of a name of a masking sound that is associated with the identified noise type to the wireless speaker 1, or transmits, to the wireless speaker 1, audio data of a masking sound associated with the identified noise type which is acquired from the media server 3 or read out of pre-registered pieces of audio data of masking sounds. The remote controller 2 thus causes the wireless speaker 1 to reproduce and output a masking sound that has a high masking effect on a changed noise in the surroundings. Accordingly, even when the noise in the surroundings changes during reproduction of a masking sound by the wireless speaker 1, the wireless speaker 1 is enabled to always reproduce and output a masking sound that has a high masking effect on a noise in the surroundings.

The present invention is appliable to a wide range of devices and systems that overlay a masking sound on a noise in the surroundings.

### REFERENCE SIGNS LIST

1: wireless speaker 2: remote controller
3: media server 4: network
5: access point 10: wireless interface unit
11: instruction reception unit 12: audio acquisition unit
13: audio reproduction unit 14: audio output unit
15: masking sound information storage unit 16: sound collection unit
17: frequency characteristic analysis unit 18: masking sound selection unit

1. A masking sound selection device for selecting a masking sound to be overlaid on an ambient sound, the masking sound selection device comprising:
masking sound information storage means for storing, for each noise type, information about a masking sound;
sound collection means for collecting the ambient sound;
frequency characteristic analysis means for analyzing a frequency characteristic of audio data of the ambient sound collected by the sound collection means; and
masking sound selection means for identifying a noise type of the ambient sound based on the frequency characteristic analyzed by the frequency characteristic analysis means, and selecting, as the masking sound to be overlaid on the ambient sound, a masking sound that is identified from a piece of information stored in the masking sound information storage means in association with the noise type.

2. The masking sound selection device according to claim 1, further comprising:
reproduction means for reproducing audio data of the masking sound selected by the masking sound selection means; and
output means for outputting the audio data of the masking sound that is reproduced by the reproduction means.

3. The masking sound selection device according to claim 2, wherein the frequency characteristic analysis means is configured to analyze, in a case in which the reproduction means is reproducing the masking sound, a frequency characteristic of differential data that represents a difference between the audio data of the ambient sound collected by the sound collection means and the audio data of the masking sound that is being reproduced.

4. The masking sound selection device according to claim 1, further comprising reproduction instruction means for notifying, to an audio device, a reproduction instruction accompanied by specification of the masking sound selected by the masking sound selection means.

5. The masking sound selection device according to claim 1, further comprising masking sound transmission means for transmitting, to an audio device, audio data of the masking sound selected by the masking sound selection means.

6. The masking sound selection device according to claim 5, wherein the frequency characteristic analysis means is configured to analyze, in a case in which the audio device is reproducing the audio data of the masking sound that is transmitted by the masking sound transmission means, a frequency characteristic of differential data that represents a difference between the audio data of the ambient sound collected by the sound collection means and the audio data of the masking sound that is being reproduced.

7. The masking sound selection device according to claim 1,
wherein the masking sound information storage means is configured to store, for each noise type, pieces of information about a plurality of masking sounds, with each of the pieces of information being associated with a reproduction time slot, and
wherein the masking sound selection means is configured to select, as the masking sound to be overlaid on the ambient sound, a masking sound identified from one of the pieces of information that is stored in the masking sound information storage means in association with the noise type of the ambient sound and with a reproduction time slot in which a current time is included.

8. The masking sound selection device according to claim 1, further comprising biological information acquisition means for acquiring biological information of a user,
wherein the masking sound information storage means is configured to store, for each noise type, pieces of information about a plurality of masking sounds, with each of the pieces of information being associated with a state of mind and body of the user, and
wherein the masking sound selection means is configured to select, as the masking sound to be overlaid on the ambient sound, a masking sound identified from one of the pieces of information that is stored in the masking sound information storage means in association with the noise type of the ambient sound and with a state of mind and body of the user that is indicated by the biological information acquired by the biological information acquisition means.

9. A program for causing a computer to function as a masking sound selection device for selecting a masking sound to be overlaid on an ambient sound,
the program causing the computer to function as:
masking sound information storage means for storing, for each noise type, information about a masking sound;
sound collection means for collecting the ambient sound;
frequency characteristic analysis means for analyzing a frequency characteristic of audio data of the ambient sound collected by the sound collection means; and
masking sound selection means for identifying a noise type of the ambient sound based on the frequency characteristic analyzed by the frequency characteristic analysis means, and selecting, as the masking sound to be overlaid on the ambient sound, a masking sound that is identified from a piece of information stored in the masking sound information storage means in association with the noise type.

10. A masking sound selection method of selecting, by a masking sound selection device, a masking sound to be overlaid on an ambient sound, the masking sound selection method comprising:
collecting, by the masking sound selection device, the ambient sound and analyzing a frequency characteristic of audio data of the ambient sound;
identifying, by the masking sound selection device, a noise type of the ambient sound based on the analyzed frequency characteristic; and
selecting, by the masking sound selection device, as the masking sound to be overlaid on the ambient sound, a masking sound that is identified from a piece of information registered in advance in association with the identified noise type.
